(19) United States
(12) Patent Application Publication
(10) Pub. No.: US 2014/0164052 A1
(43) Pub. Date: Jun. 12, 2014

(54) System and Method for Managing and Displaying Company Policy Data

(71) Applicant: HARTFORD FIRE INSURANCE COMPANY, Hartford, CT (US)

(72) Inventors: Jennifer Pesci-Anderson, Windsor Locks, CT (US); William Joseph Carroll, Vernon, CT (US); Brian J. Coleman, Stafford Springs, CT (US); John T. Devlin, Avon, CT (US); Jonathan David Humpherys, Simsbury, CT (US); David E. Leathers, Burlington, CT (US); Kathy A. Vecchiarelli, Aiken, SC (US)

(73) Assignee: HARTFORD FIRE INSURANCE COMPANY, Hartford, CT (US)

(21) Appl. No.: 13/719,727

(22) Filed: Dec. 19, 2012

Related U.S. Application Data
(60) Provisional application No. 61/736,191, filed on Dec. 12, 2012.

(51) Int. Cl. G06Q 10/00

(52) U.S. Cl. CPC G06Q 10/00
USPC 705/7.28; 705/342; 705/319; 705/37; 705/317

(57) ABSTRACT

A management system for administering and managing corporate policy data in an intranet based graphical user environment is disclosed. The intranet based graphical user environment communicates with a policy management data server to provide policy data to employees and third party vendors. The system selectively formats and displays policy content customized for each user requesting the data.

### REFERENCE TO RELATED APPLICATION

This application claims benefit of and priority to U.S. Provisional Patent Application Ser. No. 61/736,191, filed Dec. 12, 2012, entitled System and Method for Managing and Displaying Company Policy Data, which application is incorporated herein by reference for all purposes.

### BACKGROUND

A company or corporate policy refers to a documented set of basic governing principles and associated guidelines and rules that are formulated and enforced by a corporate organization. These policies affect and may limit a company's procedures, decisions and actions when conducting its normal course of business. Policies help to assess and mitigate risk, create transparency and promote ethical and responsible decision-making Policies may include documents that relate to Code of Conduct, Equal Employment Opportunity/Affirmative Action, Sexual and Other Unlawful Harassment, Drug Free Workplace/Prohibited Substances, Trading in Securities, Electronic Device Usage, Regulatory Affairs and Quality Assurance, Employee, Customer and Vendor Privacy, Improper Payments, Business Resiliency, Procurement and Operational Risk Management as well as many other areas.

Companies in the financial services and insurance industry need to implement, manage and enforce a greater inordinate number of policies compared to typical companies in many other fields. These large number of policies may be dictated all or in part by internal controls as well as state and federal agencies like the Department of Insurance, Securities and Exchange Commission (SEC) and Financial Industry Regulatory Authority (FINRA) and additionally certain laws standards such as the Payment Card Industry Data Security Standard (PCI DSS), legislation such as Gramm-Leach-Bliley and Health Insurance Portability and Accountability Act (HIPAA,) as well as international standards such as those promulgated by the International Organization for Standardization (ISO).

In order to try and help manage and enforce such a large number of policies, corporations have internalized governance, risk and compliance platforms to try and manage the dissemination, updating and enforcement of the ever growing number of internal corporate policies. These platforms provide basic management and access to such policies but are generally decentralized, archaic and spread out over many departments and functional areas. Accordingly, without easily accessible and understandable centralized repositories for policies, it is difficult for employees to not only locate policies, access and most of all, understand all these types and kinds of policies in a modern corporation, especially in the financial service/insurance sector. Accordingly, it would be desirable to have a system that could provide employees with improved policy management and access that has an easy to use and understand interface.

### SUMMARY

In one embodiment, the present invention is a system for intelligently administering and displaying corporate policy data including interfacing a company intranet portal platform with a policy management platform, the system comprising: at least one processor; a memory coupled to the at least one processor; and one or more programs, wherein the one or more programs are stored in the memory and configured to be executed by the at least one processor, the one or more programs including instructions for: caching policy data in the intranet portal platform, the policy data associated with a plurality of corporate policy documents; updating the corporate policy documents from one or more third party data sources; determining a policy option selection of an employee based at least in part on employee role and historical data; storing the determined policy option selection in a storage device; configuring the determined policy option selection for optimized display on a graphical user interface screen; and displaying the determined policy option selection on the graphical user interface screen.

In other embodiments, the present invention is a computer system for providing financial services/insurance policy options to a user comprising a corporate intranet communications network; a processor coupled to the corporate intranet communications network; and at least one storage device in communication with the processor; the processor configured to: update a plurality of corporate policies for storage on the at least one storage device; receive corporate policy requests via the corporate intranet communications network from one or more users, each user having an associated user profile; selectively format for display the requested corporate policy based on the requesting user profile; and display the corporate policy in accordance with the user profile.

The present invention is also a computer-implemented method for administering insurance industry related policy data stored in a policy management system for use in an intranet environment comprising: receiving, via the intranet environment, a policy option selection of at least one of a company employee and a company vendor; configuring the requested policy option selection for display on a graphical user interface screen; and displaying the determined policy option selection on the graphical user interface screen, wherein the policy data is cached in the intranet environment.

### BRIEF DESCRIPTION OF THE DRAWINGS

A more detailed understanding may be had from the following description, given by way of example in conjunction with the accompanying drawings wherein:

FIG. 1 shows an exemplary computer architecture that may be used for policy data administration and management;

FIG. 2 shows an exemplary system that may be used for the management of policy data;

FIG. 3 shows an exemplary policy management platform of the present invention;

FIG. 4 shows an exemplary policy management platform in communication with a portal platform of the present invention;

FIGS. 5a-5f show exemplary system screens of the present invention;

FIG. 6 shows another exemplary method of the present invention;

FIG. 7 shows another exemplary device of the present invention; and

FIG. 8 shows another exemplary system platform of the present invention.

### DETAILED DESCRIPTION

Disclosed herein are processor-executable methods, computing systems, and related technologies for the administration, management and processing of corporate policy data through implementation of a centralized, authoritative solution for managing policy content and access. This policy management system solves prior art issues related to control, access and usability by providing a system that is implemented using a graphical user interface of a familiar corporate intranet environment that interfaces with a corporate policy management platform. This system allows a company to stay current with policies and standards and manage risk and exceptions and at the same time provides the ability to extract policy and standard information at an appropriate level that is then presented to the general employee population in the context of a familiar intranet portal environment.

The present invention promotes access and understanding of the obligations of corporate policies and standards that is critical to modern operational risk management. Having policies that are easily electronically accessible and easily searchable for employees provides a huge benefit overall for corporate policy governance and risk posture and directly impacts the financial performance and results of a company in today's competitive business environment.

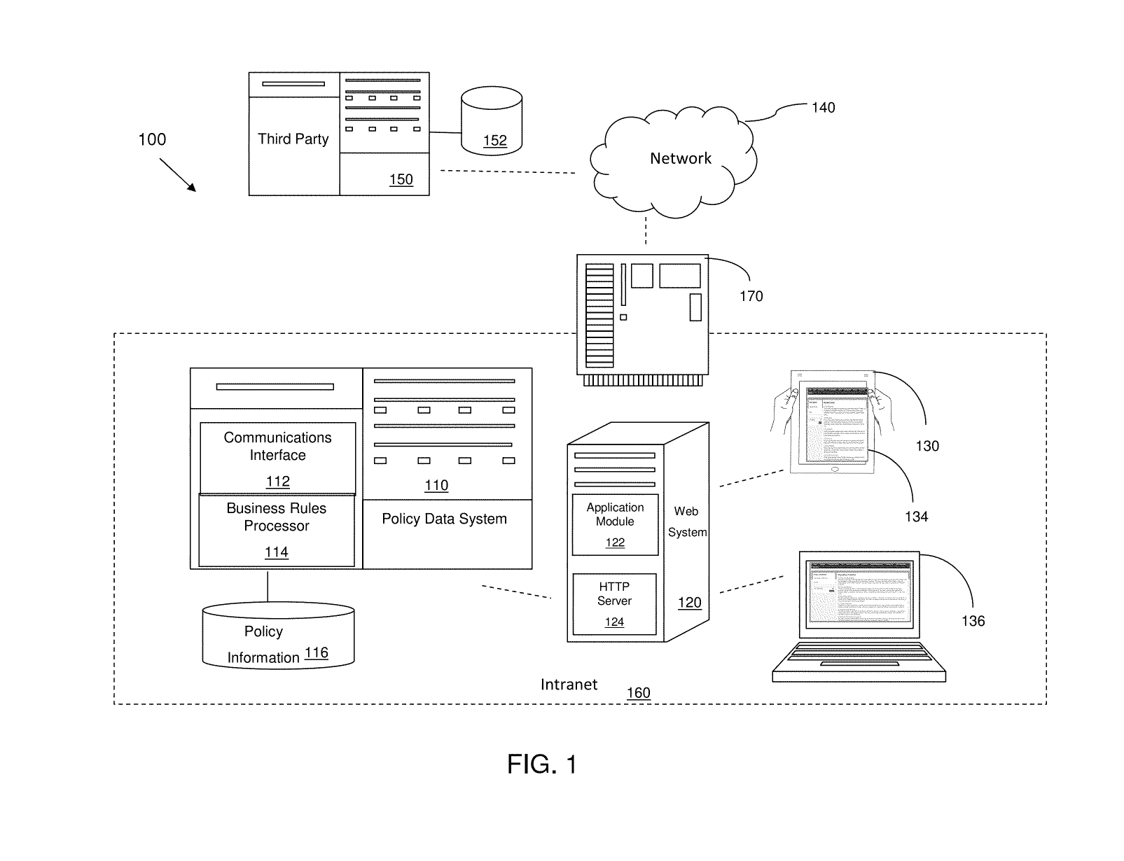

FIG. 1 shows an example system architecture 100 that may be used for the administration and management of insurance and financial services company policy data such as privacy, business resiliency, procurement and operational risk management among others. The example architecture 100 may include a policy data system or policy management platform 110, a web system 120, client/user devices 130 and 136, a network 140, and at least one third party data system 150 and third party database 152. In one embodiment, policy data system 110, web system 120, and client devices 130 and 136 comprise at least part of a company intranet 160 that is communication with network 140 via an intermediary server 170. Company intranet 160 shown in FIG. 1 is an embodiment of a computer network that might be implemented within the corporate office headquarters of a financial services/insurance company to allow communications and data transfer between company employees. Data transferred through network 140 to an intermediary server 170 inside the Intranet 160 may pass through one or more firewalls or other security type controls implemented via intermediary server 170 and intranet 160. The firewall allows access to network 140 only through predetermined conditions/ports. In another embodiment, the firewall restricts the Internet IP addresses that may access intermediary server 170. Vendors and other third parties may be given limited access to intranet 160 to access and view policy data in accordance with the present invention. Utilizing system 100, a company may monitor and keep track of vendor compliance with company policies and a vendor may view and access policies and demonstrate compliance with one or more of the policies.

Referring still to FIG. 1, the policy data system 110 may include a communications interface 112, a business rules processor 114, and a policy information database 116. The business rules processor 114 may include one or more business rules and one or more predictive models in conjunction with one or more software modules or objects and one or more specific-purpose processor elements to perform the calculations and processing required by the present invention such as for determining policy preferences, determining policy option selections, and configuring selected policy option selections for display. Determining a policy option selection of at least one employee may be based at least in part on the employee's role and historical viewing data. Business rules governing policy option selections, such as what policies to display, how to display them and how the policies are formatted for display may be implemented in accordance with the present invention such as rules correlating policy display formats to employee role and rank, rules correlating policy display formats to historical viewing preferences, and rules correlating policy display formats to social media and current events. For example, if a current event or social media discussion relates to a privacy information breach, then the system may default to predictively providing an information protection policy to users upon initial access by the user. The system may proactively poll for such current events or popular social media discussion and predictively serve up certain policies to users either by request or by pushing the policy data to users. The system may be configured to conduct keyword, phrase or other suitable searches of databases of current events data, social media discussion data, including original source data and extracted databases, and apply business rules, such as business rules associating policies to keywords and/or phrases to the search results to identify policies of particular priority at a particular time or day. Rules may be provided to convert numbers of identifications, and importance of identifications, such as by weighting greater importance to publications within the same industry segment or mentions associated with names of other companies in the same industry segment, of words or phrases linked to particular policies to numerical values. Based on such importance values, policies may be selected, such as by business rules processor 114, in the policy option selection, based entirely or in part on current events or current social media mention data.

The policy information database 116 may store information, data and documents that relate to corporate policies such as those related to Code of Conduct, Information Protection, Equal Employment Opportunity/Affirmative Action, Sexual and Other Unlawful Harassment, Drug Free Workplace/Prohibited Substances, Trading in Securities, Electronic Device Usage, Regulatory Affairs and Quality Assurance, Employee, Customer and Vendor Privacy, Improper Payments, Business Resiliency, Procurement and Operational Risk Management as well as many other areas. Policy information database 116 may be spread across one or more computer-readable storage media, and may be or include one or more relational databases, hierarchical databases, object-oriented databases, one or more flat files, one or more spreadsheets, and/or one or more structured files. Policy information database 116 may be managed by one or more database management systems (not depicted), which may be based on a technology such as Microsoft SQL Server, MySQL, Oracle Relational Database Management System (RDBMS), PostgreSQL, a NoSQL database technology, and/or any other appropriate technology.

Communication between the policy data system 110 and the other elements in the example architecture 100 of FIG. 1 may be performed via the communications interface module 112 interacting within intranet 160. The policy data system 110 may also access third party systems 150 and third party data 152 via network 140. For example, policy data system 110 may interface with computer systems associated with one or more third party sites to receive data from one or more state and federal agencies like the Department of Insurance, Securities and Exchange Commission (SEC), Equal Employment Opportunity Commission (EEOC) and Financial Industry Regulatory Authority (FINRA) among others. Third party sites may also include e-commerce sites, utility provider sites, social networks, blogs and other varieties of sites in the Internet.

Referring still to FIG. 1, a web site system 120 may provide an intranet based web site that may be accessed directly by a user such as an insurance company employee or vendor operating user client devices 130 and 136. In certain embodiments, user client device 130 can include, but is not limited to cellular telephones, other wireless communication devices, personal digital assistants, pagers, laptop computers, tablet computers, smartphones, or combinations thereof. In the present invention, user client device 130 may communicate with the web site system 120 that may be operated by or under the control of an insurance entity or other third party entity such as an outsourced type entity or third party administrator type entity. The web site system 120 may generate one or more web pages for access by client device 130, and may receive responsive information from the client device 130 such as certain requested policy information. The web site system 120 may then communicate this information to the policy data system 110 for processing via communications interface 112.

In operation, client device 130 may be used to select, access and view one or more corporate policies in accordance with the historical needs, job type and job role of a user associated with the client device 130. Selection via client device 130 may be accomplished via a touch-sensitive touch screen that provides an input interface and an output interface between the client device 130 and the client or user. The client device 130 displays visual output to the user for manipulation by the user. The visual output may include checkboxes, radio buttons, graphics, text, icons, video, and any combination thereof. The touch screen may display one or more graphics within user interface displayed on device 130. In this embodiment, as well as others, a user may select one or more of the graphical elements by making contact or touching the graphics, for example, with one or more fingers or stylus implements such as a policy display, which, based on a policy option selection determined by the system, may have certain expandable and collapsible components or areas that may be selectively hidden or obscured from immediate view based on the employee's job role, title and/or historical preferences. For example, in one exemplary embodiment, a policy option selection for a certain tier or level of employee may cause such a tier or level of employee to be shown a high level visual presentation of policy data where a relatively lower level of employee may be shown more granular or detailed data related to the policy being shown. In embodiments of the present invention, the requesting user's profile such as their job role, title, preferences either explicit or historical will determine policy option selections such as certain collapsible and expandable display sections of the corporate policy are provided for viewing. In embodiments of the present invention, determining the policy option selections may result in displaying the corporate policy in accordance with the user profile by selectively displaying certain pre-determined sections of the corporate policy or obscuring certain sections from immediate viewing.

The web site system 120 may include an web application module 122 and a HyperText Transfer Protocol (HTTP) server module 124. The web application module 122 may generate the web pages that make up the web site and that are communicated by the HTTP server module 124. Web application module 122 may be implemented in and/or based on a technology such as Active Server Pages (ASP), PHP: Hypertext Preprocessor (PHP), Python/Zope, Ruby, any server-side scripting language, and/or any other appropriate technology.

The HTTP server module 124 may implement the HTTP protocol, and may communicate HyperText Markup Language (HTML) pages and related data from the web site to/from client devices 130 and 136 using HTTP. The HTTP server module 124 may be, for example, a Sun-ONE Web Server, an Apache HTTP server, a Microsoft Internet Information Services (IIS) server, and/or may be based on any other appropriate HTTP server technology. The web site system 120 may also include one or more additional components or modules (not depicted), such as one or more switches, load balancers, firewall devices, routers, and devices that handle power backup and data redundancy.

Referring still to FIG. 1, the client device 130 may include a web browser module 134, which may communicate data related to the web site to/from the HTTP server module 124 and the web application module 122 in the web site system 120. The web browser module 134 may include and/or communicate with one or more sub-modules that perform functionality such as rendering HTML (including but not limited to HTML5), rendering raster and/or vector graphics, executing JavaScript, and/or rendering multimedia content. Alternatively or additionally, the web browser module 134 may implement Rich Internet Application (RIA) and/or multimedia technologies such as Adobe Flash, Microsoft Silverlight, and/or other technologies. The web browser module 134 may implement RIA and/or multimedia technologies using one or web browser plug-in modules (such as, for example, an Adobe Flash or Microsoft Silverlight plugin), and/or using one or more sub-modules within the web browser module 134 itself. The web browser module 134 may display data on one or more displays that are included in or connected to the client device 130, such as a liquid crystal display (LCD) display, organic light-emitting diode (OLED) display, touch screen or monitor. The client device 130 may receive input from the user of the client device 130 from input devices (not depicted) that are included in or connected to the client device 130, such a mouse or other pointing device, or a touch screen, and provide data that indicates the input to the web browser module 134.

The example architecture 100 of FIG. 1 may also include one or more wired and/or wireless networks within intranet 160 and as between network 140 and intranet 160 via which communications between the elements and component shown in the example architecture 100 may take place. The networks may be private or public networks, cloud or shared networks and/or may include the Internet.

Each or any combination of the components/modules 112, 114, 122, and 124 shown in FIGS. 1 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 1, these modules 112, 114, 122, and 124 may perform functionality described later herein.

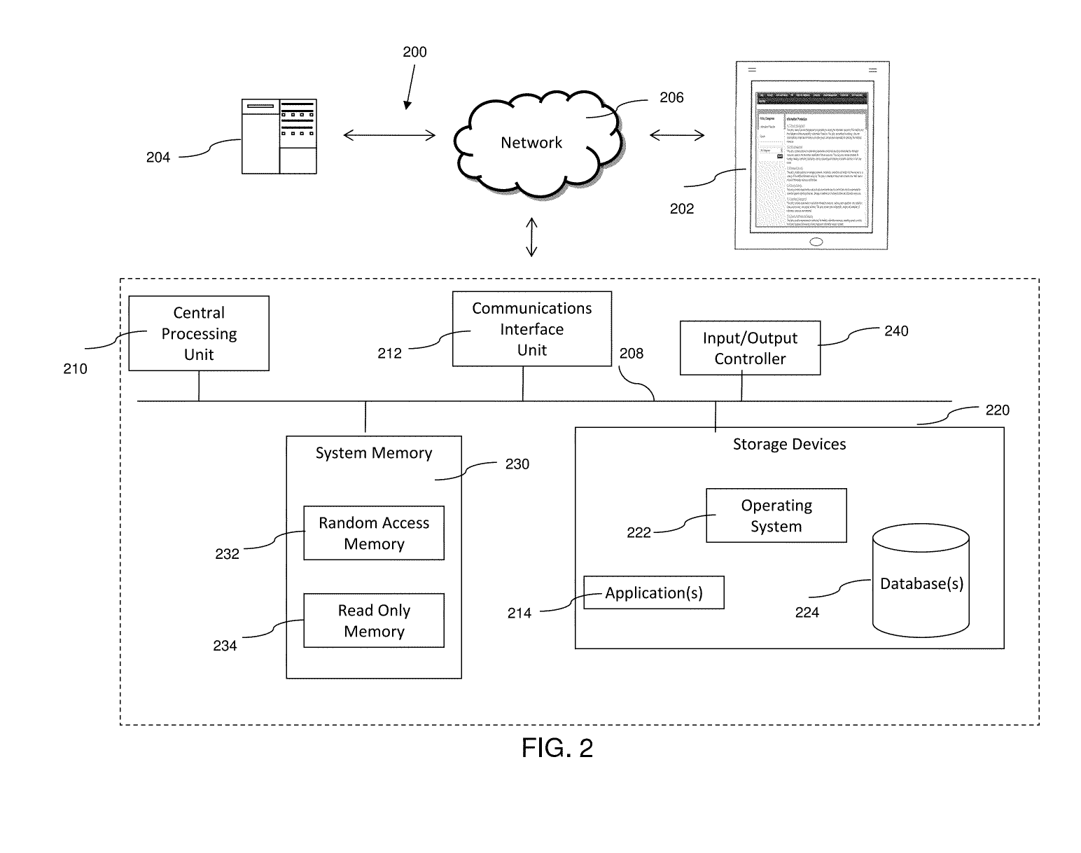

Referring to FIG. 2, an exemplary computer system 200 for use in an implementation of the invention will now be described. Computer system 200 may be configured to perform policy data processing and management for one or more company employees and/or vendors 202. System 200 may interface with a policy data system 204 via a network 206 which may be a company intranet network. In embodiments of the present invention, policy data system 204 is responsible for the primary policy functions associated with a company's corporate policies such as management, updating, storage and dissemination/distribution. For example, updating the corporate policy documents or data may include accessing one or more third party data sources such as a federal or state regulatory database. For example, policy data system 204 may incorporate data relating one or more policies and/or policy elements, such as sections or standards, to one or more Federal or state regulations. Policy data system 204 may be configured to access one or more third party data sources on a periodic basis, determine whether any of the Federal or state regulations have been changed, and implement updates to policy data responsive to the changes to Federal or state regulations. Similarly, policy data system 204 may be configured to access other third party data sources and update policy data responsive to changes. In embodiments, policy data system may be configured to implement updates autonomously, or may prompt an authorized user for approval or disapproval after identifying a change in a third party data source. In computer system 200, a central processing unit or processor 210 executes instructions contained in programs such as policy management application program 214, stored in storage devices 220. Processor 210 may provide the central processing unit (CPU) functions of a computing device on one or more integrated circuits. As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

Storage devices 220 may include suitable media, such as optical or magnetic disks, fixed disks with magnetic storage (hard drives), tapes accessed by tape drives, and other storage media. Processor 210 communicates, such as through bus 208 and/or other data channels, with communications interface unit 212, storage devices 220, system memory 230, and input/output controller 240. System memory 230 may further include non-transitory computer-readable media such as a random access memory 232 and a read only memory 234. Random access memory 232 may store instructions in the form of computer code provided by application 214 to implement the present invention. System 200 further includes an input/output controller 240 that may communicate with processor 210 to receive data from user inputs such as pointing devices, touch screens, and audio inputs, and may provide data to outputs, such as data to video drivers for formatting on displays, and data to audio devices.

Storage devices 220 are configured to exchange data with processor 210, and may store programs containing processor-executable instructions, and values of variables for use by such programs. Processor 210 is configured to access data from storage devices 220, which may include connecting to storage devices 220 and obtain data or read data from the storage devices, or place data into the storage devices. Storage devices 220 may include local and network accessible mass storage devices. Storage devices 220 may include media for storing operating system 222 and mass storage devices such as storage 224 for storing data related to corporate policies and employee policy preferences.

Communications interface unit 212 may communicate via network 206 with other financial services/insurance company computer systems such as policy data system servers 204 as well as other servers, computer systems of remote sources of data, and with systems for implementing instructions output by processor 210. Policy data system server 204 may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SASTM, ATP, Bluetooth, GSM and TCP/IP. Network 206 may be or include wired or wireless local area networks and wide area networks, and over communications between networks, including over the Internet.

One or more public cloud, private cloud, hybrid cloud and cloud-like networks may also be implemented, for example, to handle and conduct processing of one or more transactions or processing of the present invention. Cloud based computing may be used herein to handle any one or more of the application, storage and connectivity requirements of the present invention. For example one or more private clouds may be implemented to handle corporate policy processing and storage of the present invention. Furthermore, any suitable data and communication protocols may be employed to accomplish the teachings of the present invention.

With reference still to FIG. 2, communications interface 212 is used for receiving user data related to the user's policy requests made via a company intranet. Computer processor 210 executes program instructions, such as program instructions provided by application 214 to receive, via the communications interface 212, third party data, social network data and other related information. Database 224 may include transaction data such as historical data from the user or other third parties.

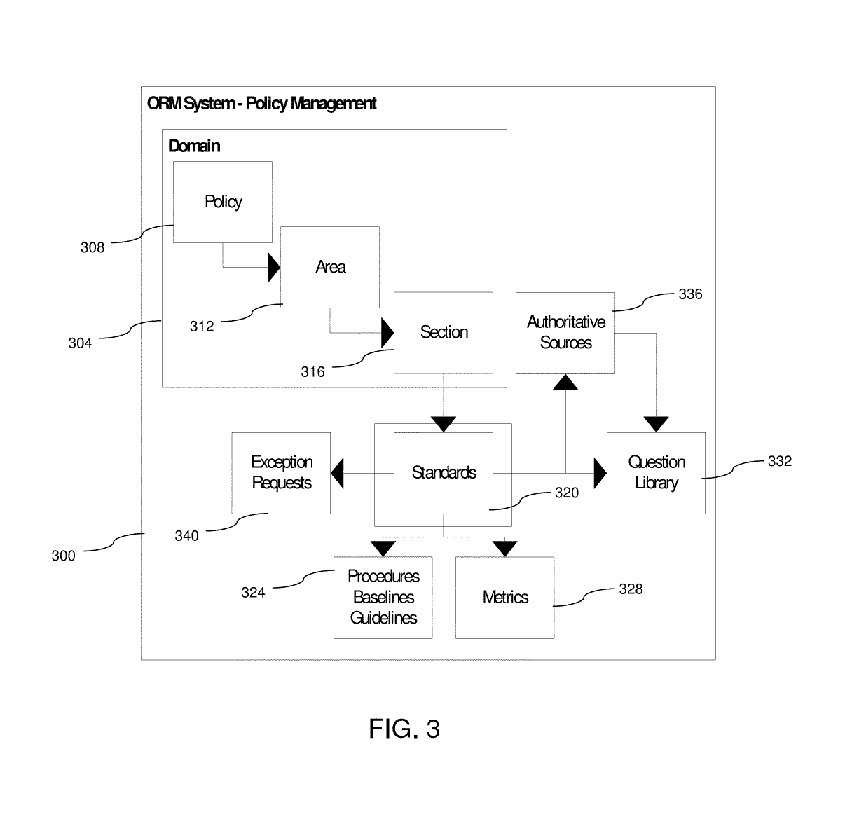

FIG. 3 illustrates an exemplary configuration of a policy data system or policy management platform 300 as discussed with respect to FIGS. 1 and 2. In this configuration, a policy grouping or domain 304 is established for each organizational area that owns the respective policy 308. Policy 308 may be further delineated in a variety of levels where the policy 308 is a high level statement of management expectations, area 312 describes a specific area of focus of the policy and its intent and section 316 provides additional level of detail and links to standards 320. Standards 320 may be the actionable tasks and responsibilities that employees must implement to meet policy requirements. Standards 320 are linked to certain procedures, baselines and guidelines 324 as well as metrics 328. Standards 320 are further linked to a question library 332 and certain authoritative sources 336. Standards 320 may be further linked to exception requests 340 for exception handling of one or more questions for deviation from one or more policy requirements.

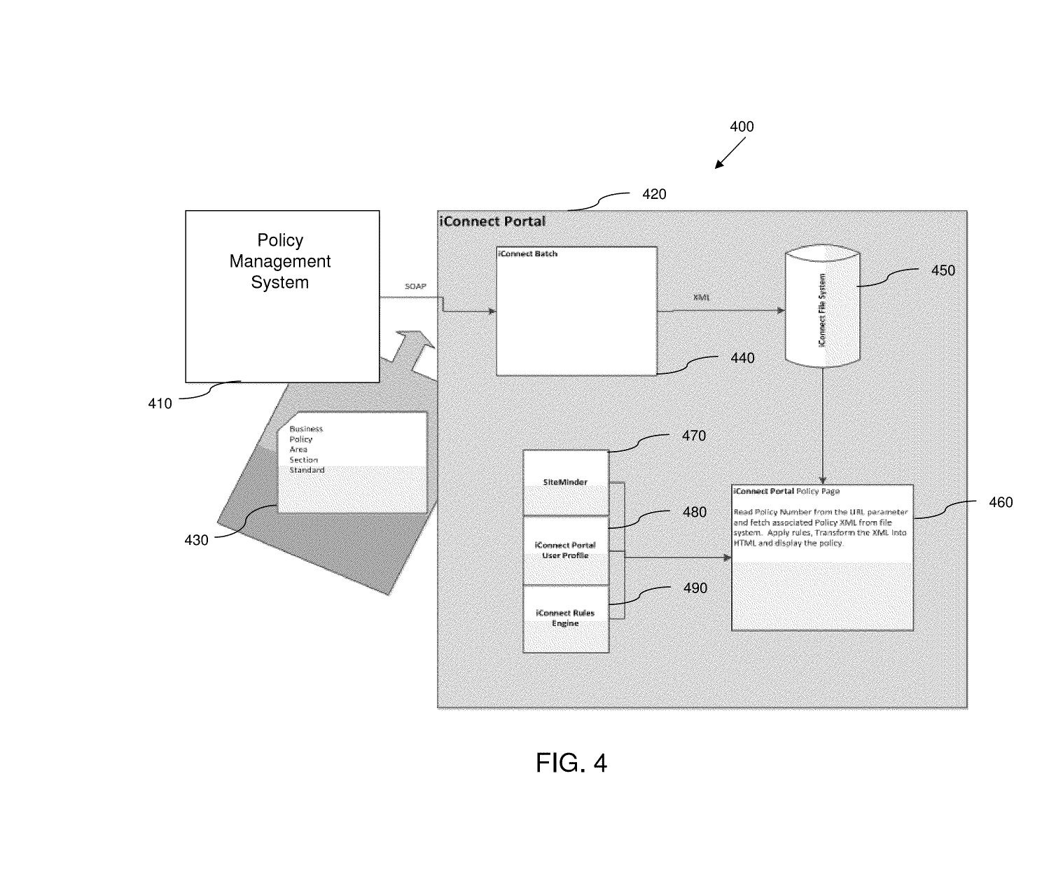

FIG. 4 illustrates an exemplary system framework 400 of the present invention. System framework 400 includes a corporate policy management system 410 that is in communication with a company intranet portal platform 420, which may also be termed a corporate intranet communications network platform. Company intranet portal platform 420 is sized and designed for heavy traffic and thus alleviates the overloading that may occur to policy management system 410 which conventionally would not be able to accommodate the traffic load. Embodiments of the present invention utilizes caching of the policy data 430 within company intranet portal platform 420 such as one or more company intranet portal servers to speed distribution and access of the policies to users and minimize the strain to the policy management system 410.

Policy data 430 is transmitted by either a push or pull methodology where the policy management system 410 may push data to the portal 420 or the portal 420 may pull data from the policy management system 410. Policy management system 410 and company portal may utilize a Service-Oriented Architecture (SOA) and use Simple Object Access Protocol (SOAP) for the transmission of messages and data within the system. Policy data 430 may be associated with multiple corporate policy documents. Policy data 430 may be provide to a batch 440 linked to a file system 450. File system 450 is coupled to a portal page 460 for the viewing and accessing of policy data by one or more company employees or vendors. Portal page 460 may also be coupled to one or more of a management module 470, one or more user profiles 480 and a rules engine 490. Management module 470 may provide a centralized Web access management system that enables user authentication and sign-on, policy-based authorization, identity federation, and auditing of access to a variety of Web applications and portals. User profiles 480 are records of user-specific data that define and categorize the user's preferences and working environment and can include policy preferences, display settings, application settings, and network connections. Rules engine 490 are individual and/or grouped logic or rules resident in application program code that help define which policies to display to a user and how to display each policy to each user, such as based on the employee's role, rank, title and based on information in their respective user profiles 480 that define their policy preferences.

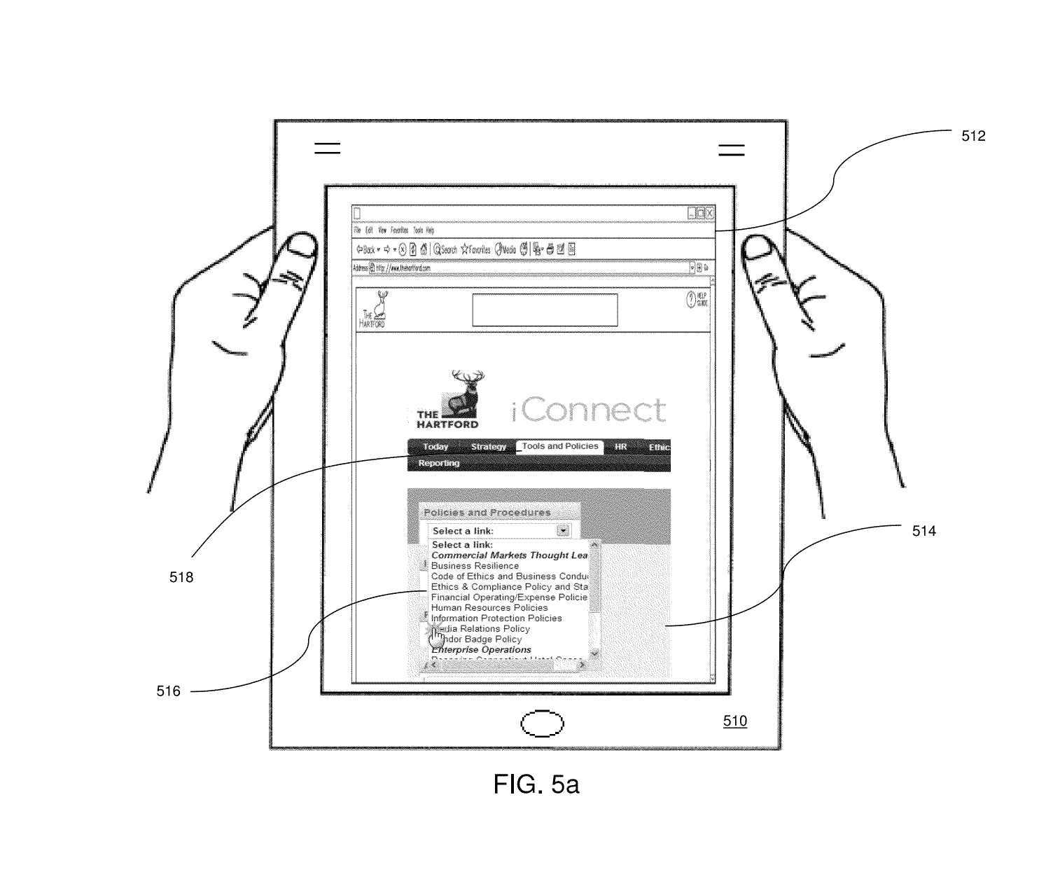

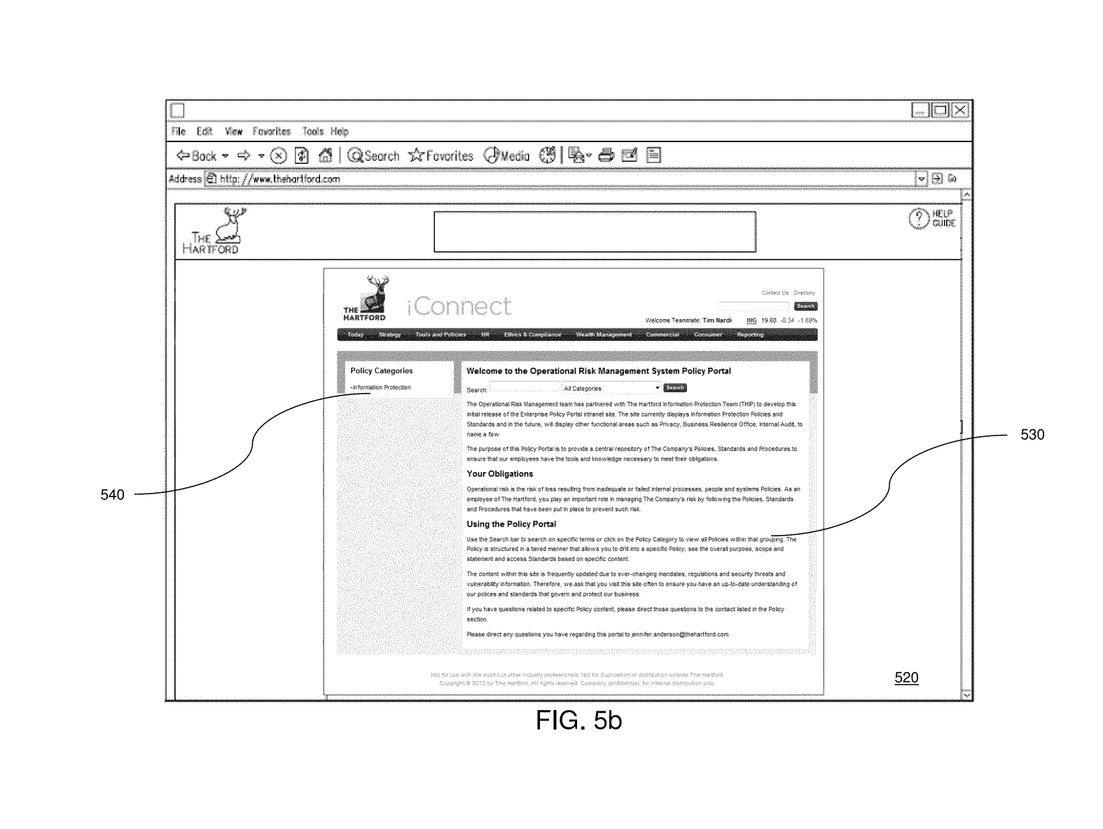

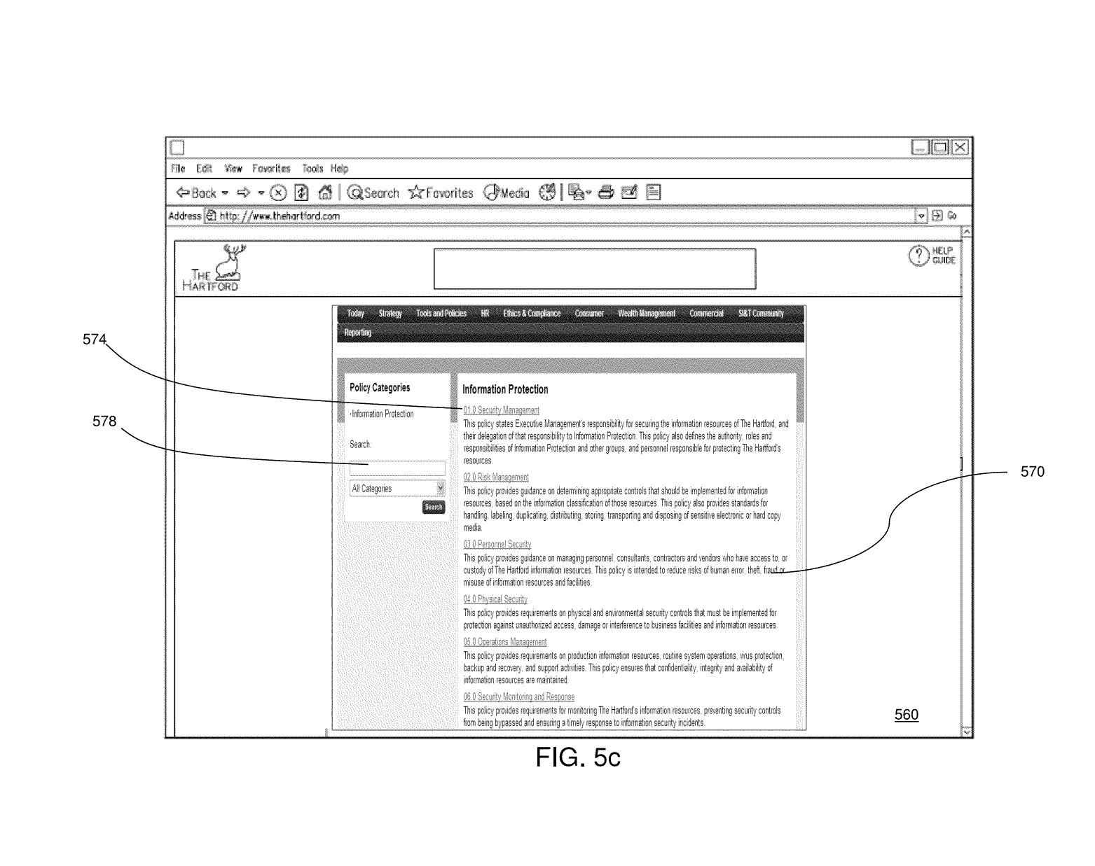

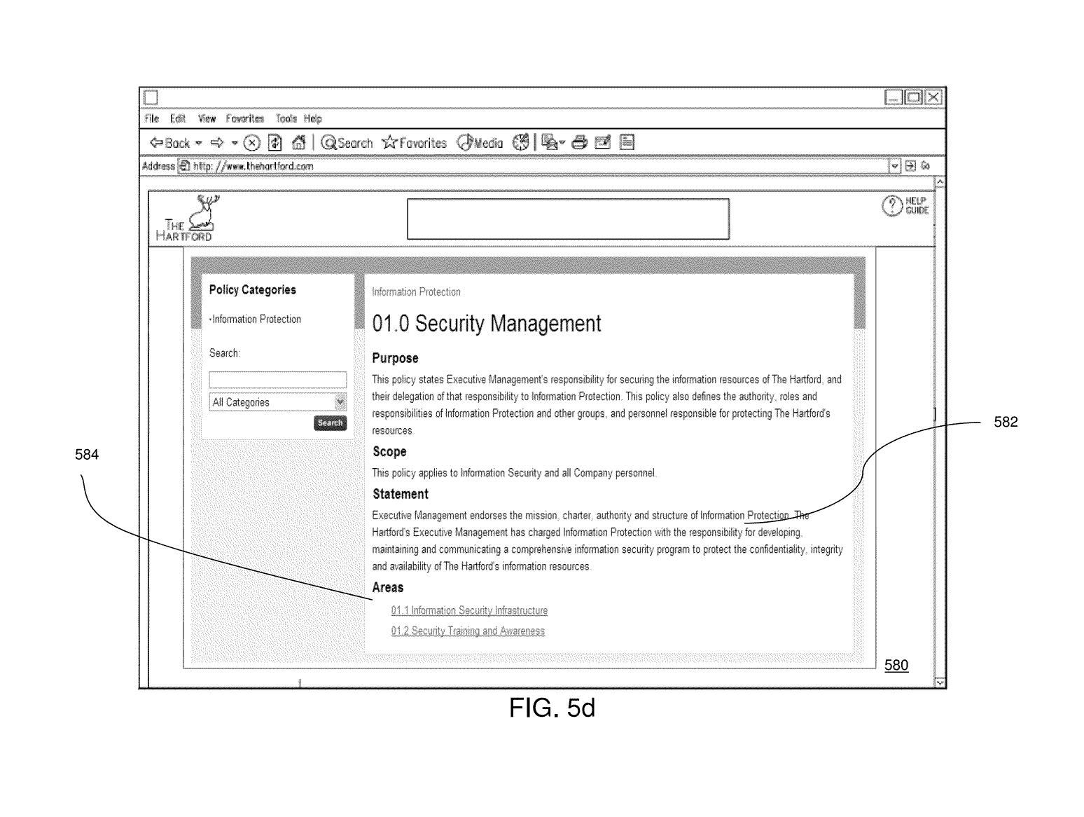

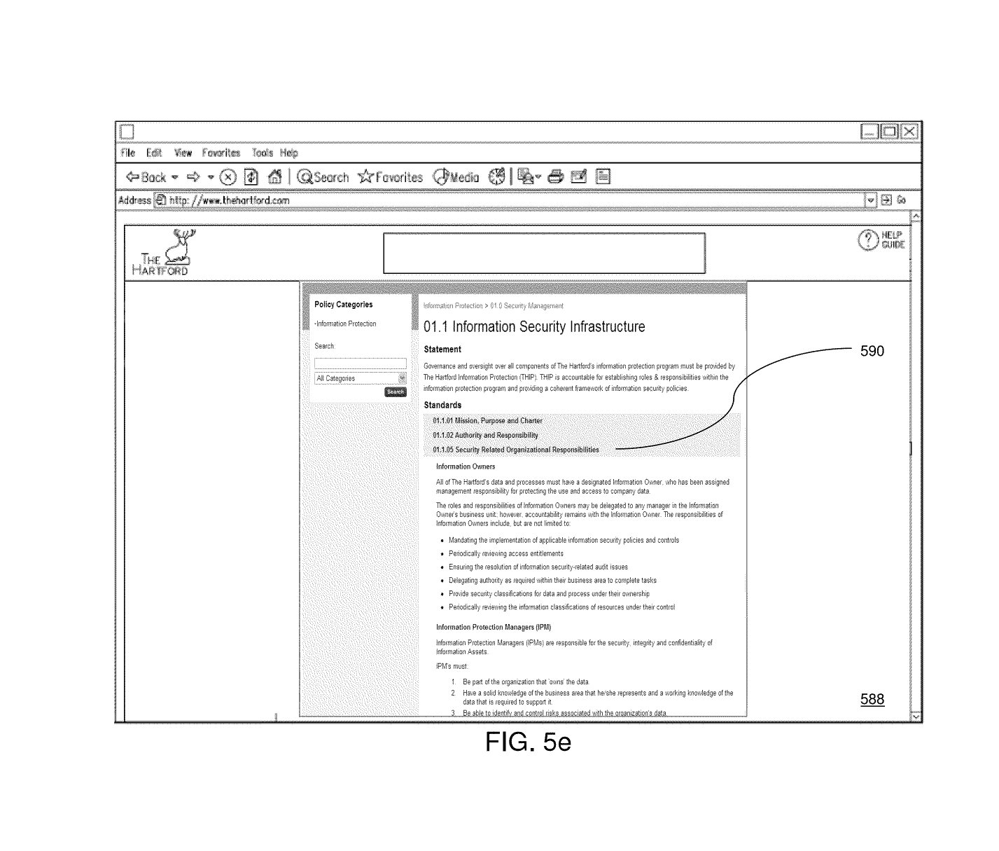

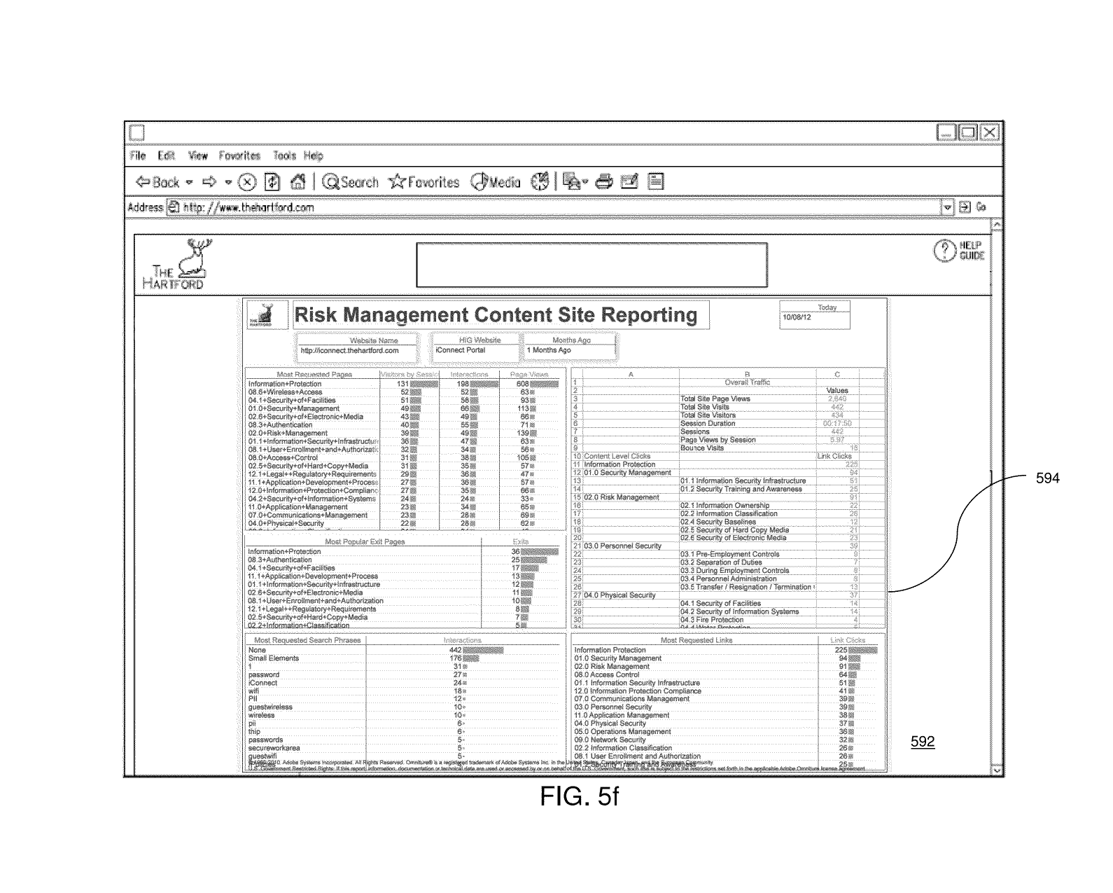

FIGS. 5a-5f illustrate a series of exemplary screens of the present invention as may be displayed among devices shown in FIGS. 1 and 2. FIGS. 5a-5e illustrate a series of related exemplary screens that iteratively relate to a policy a user may be viewing where each screen provides successively more detailed view of the respective policy. Referring first to FIG. 5a, in one embodiment, a user operates a device 510, such as a portable computing device for viewing and accessing information and data related to one or more company policies as described herein. Portable computing device 510 may include a touch screen 512 that can be an active sensor employing capacitive, resistive, inductive, or other methods, or it can be a passive surface on which touch sensing is accomplished by optical, acoustic, or other similar methods. Device 510 can also be a liquid crystal display (LCD), organic light emitting diode (OLED) display, electroluminescent display, or any other type of small display suitable for mounting in a portable computer or mobile device. Device 510 may be color or monochrome, and may include a backlight capability to enhance readability in various lighting conditions. In the present invention, device 510 displays a web document 514 for access by a user. Web document 514 may include an input/selection area 516 for selecting inputs related to the policy selections.

Referring still to FIG. 5a, a user with access to the company portal can select the “Tools and Policies” tab 518 on screen 512. The user may select a desired selection within the “Policies and Procedures” selection area. In this example, the user selects “Information Protection Policies” to access the respective policy portal home page for that organization. As shown in FIG. 5b, screen 520 displays a selected policy portal home page 530. Home page 530 may provide a welcome message and navigation to existing content related to the respective organizational area. This content may be organized by a policy category 540 that represents the organization that owns the policies. In the present example, the policy category 540 is “Information Protection.” Additional policy categories may be represented here in other embodiments. Selecting the “Information Protection” policy category 540 display additional information related to that policy category 540 shown in FIG. 5b.

Referring now to FIG. 5c, a display 560 of the respective policies 570 is provided for the policy category 540 of FIG. 5b that was selected. In display 560, clicking or selecting on a certain policy link 574 will bring the user down to the next level or area. In certain embodiments, the system may provide keyword search functionality 578 within display 560. Referring now to FIG. 5d, the user may selectively view further levels of the respective policy as shown in display 580. Display 580 provides additional detail for each specific policy such as purpose, scope, or other associated detail 582. Certain sections may have additional level detail for viewing such as under the “Areas” section 584. Selecting for example, “0.1.1 Information Security Infrastructure” in section 584 of FIG. 5d brings the user to the respective detail for that particular section. Referring now to FIG. 5e, the user will be able to view additional detail within display screen 588 as selected previously in FIG. 5d. Additional detail may be available within section 590 for viewing within display screen 588.

In certain embodiments, a policy option selection may be determined, in which selected sections may be immediately viewable or expanded or others initially collapsed depending on the user employee's preferences, title, role and/or predicted viewing habits. For example, in a policy option selection, one employee may be provided the display shown in FIG. 5b as their primary or initial display, whereas another employee may be provide the display shown in FIG. 5d as their default or initial screen. By way of further example, even if a policy option selection provides a same policy for two different employees, the system may configure the determined policy option selection differently for optimized display depending on employee title, rank, viewing history and other factors. By way of example, a high level executive may have a policy option selection configured for optimized display by having second and tertiary level detail initially obscured or collapsed when viewing a certain policy while a relatively lower level employee may have a same policy option selection configured for optimized display by having all levels of detail visible or expanded upon initial viewing. The user preferences may also be considered in determining policy option selections and configuring of policy options for optimized display, including the level of viewing detail initially presented to a user based on historical viewing data as well as predictive viewing data.

Referring now to FIG. 5f, one or more reports 592 may also be provided for management based on basic click-stream type activities within screens 5a-5e. Metrics may be captured based on one or more the following: Most requested pages, Top keyword searches, Number of unique visitors, Duration of visit, etc. as shown in display section 594. The metric information may be used to help predictively cache and display information to users such as by utilizing processes/modules 470 and 480 shown in FIG. 4 to provide customized displays of policy information to users.

In embodiments, monitoring vendor compliance with one or more policies may be implemented, such as by a business rules processor of a system. The system may be configured with policies with which one or more selected vendors are required to comply, and rules such as frequency of compliance and nature of compliance. Nature of compliance may include providing responses to questions in an interactive portion of a display provided by a company portal, or providing further documentation, such as copies of vendor policies or training materials, video of vendor employee training sessions, and the like. In an embodiment, upon login by a vendor employee, the vendor employee may be presented with one or more standards of one or more policies, and prompted to provide confirmation of compliance and associated documentation dependent on associated business rules. The system may further be configured to include in management reports assessments of compliance, such as testing of responses to standards against one or more metrics. The system may be configured to display to a vendor employee data indicative of vendor compliance with one or more standards or other features of one or more company policies.

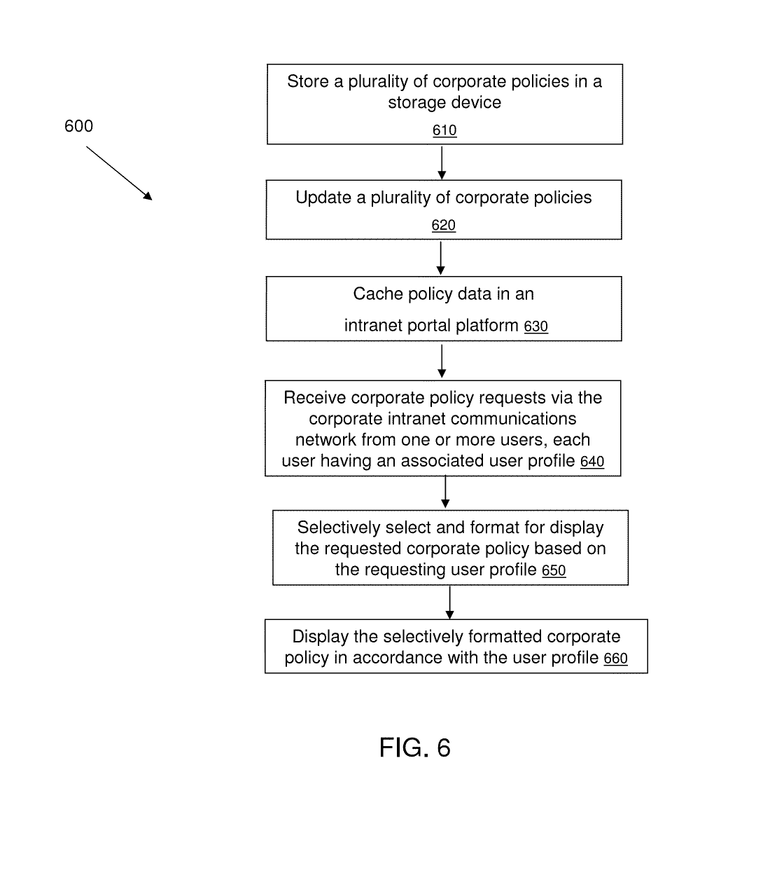

FIG. 6 shows an example process flow diagram illustrating a method 600 for administering a policy management process using the example architecture 100 of FIGS. 1 and 2. The method 600 of FIG. 6 may begin by having the system 100 of FIG. 1, store a plurality of corporate policies, step 610. System 100 may then update the plurality of corporate policies, step 620. Policy data may be cached in an intranet based platform, step 630. System 100 may proceed by receiving corporate policy requests via the corporate intranet communications network from one or more users, each user having an associated user profile, step 640. System 100 may selectively determine a format for display of the requested corporate policy based on the requesting user profile, step 650. For example, determining a policy option selection of an employee may be based at least in part on employee role and historical data includes accessing an employee title associated with the employee. System 100 would then display the selectively formatted corporate policy in accordance with the user profile, step 660.

One or more steps of method 600 may be implemented as computer program instructions provided on a non-transitory computer readable medium for execution by one or more processors. As used to herein, the term “computer-readable medium” broadly refers to and is not limited to a register, a cache memory, a ROM, a semiconductor memory device (such as a D-RAM, S-RAM, or other RAM), a magnetic medium such as a flash memory, a hard disk, a magneto-optical medium, an optical medium such as a CD-ROM, a DVDs, or BD, or other type of device for electronic data storage.

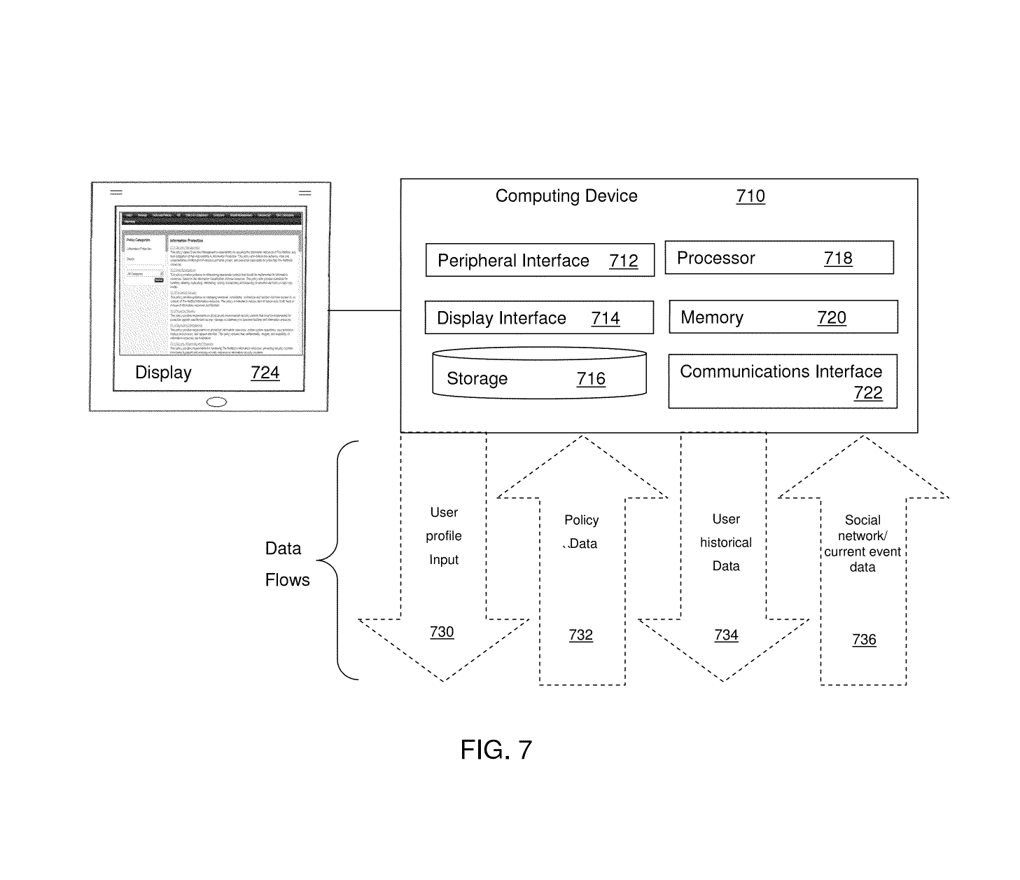

FIG. 7 shows an example computing device 710 that may be used to implement features describe above for selectively selecting, formatting and displaying corporate policy data in accordance with the present invention. The computing device 710 may include a peripheral device interface 712, display device interface 714, a storage device 716, a processor 718, a memory device 720, and a communication interface 722. Computing device 710 may be coupled to a display device 724, which may be separately coupled to or included within the computing device 710. In operation, computing device 710 is configured to receive and transmit a number of data flows via communications interface 722 including, for example, user profile data 730, policy data 732, user historical data 734 and social network/current event data 736.

The peripheral device interface 712 may be an interface configured to communicate with one or more peripheral devices. The peripheral device interface 712 may operate using a technology such as Universal Serial Bus (USB), PS/2, Bluetooth, infrared, serial port, parallel port, and/or other appropriate technology. The peripheral device interface 712 may, for example, receive input data from an input device such as a keyboard, a mouse, a trackball, a touch screen, a touch pad, a stylus pad, and/or other device. Alternatively or additionally, the peripheral device interface 712 may communicate output data to a printer that is attached to the computing device 710 via the peripheral device interface 712.

The display device interface 714 may be an interface configured to communicate data to display device 724. The display device 724 may be, for example, a monitor or television display, a plasma display, a liquid crystal display (LCD), and/or a display based on a technology such as front or rear projection, light emitting diodes (LEDs), organic light-emitting diodes (OLEDs), or Digital Light Processing (DLP). The display device interface 714 may operate using technology such as Video Graphics Array (VGA), Super VGA (S-VGA), Digital Visual Interface (DVI), High-Definition Multimedia Interface (HDMI), or other appropriate technology. The display device interface 714 may communicate display data from the processor 718 to the display device 724 for display by the display device 724. As shown in FIG. 7, the display device 724 may be external to the computing device 710, and coupled to the computing device 710 via the display device interface 714. Alternatively, the display device 724 may be included in the computing device 700.

The memory device 720 of FIG. 7 may be or include a device such as a Dynamic Random Access Memory (D-RAM), Static RAM (S-RAM), or other RAM or a flash memory. The storage device 716 may be or include a hard disk, a magneto-optical medium, an optical medium such as a CD-ROM, a digital versatile disk (DVDs), or Blu-Ray disc (BD), or other type of device for electronic data storage.

The communication interface 722 may be, for example, a communications port, a wired transceiver, a wireless transceiver, and/or a network card. The communication interface 722 may be capable of communicating using technologies such as Ethernet, fiber optics, microwave, xDSL (Digital Subscriber Line), Wireless Local Area Network (WLAN) technology, wireless cellular technology, and/or any other appropriate technology.

An instance of the computing device 710 of FIG. 7 may be configured to perform any feature or any combination of features described above as performed by user devices 130 and 136 as described with respect to FIG. 1. In such an instance, the memory device 720 and/or the storage device 716 may store instructions which, when executed by the processor 718, cause the processor 718 to perform any feature or any combination of features described above as performed by the web browser module 134. Alternatively or additionally, in such an instance, each or any of the features described above as performed by the web browser module 134 may be performed by the processor 718 in conjunction with peripheral device interface 712, display device interface 714, and/or storage device 716, memory device 720, and communication interface 722.

Alternatively or additionally, an instance of the computing device 710 may be configured to perform any feature or any combination of features described above as performed by the policy data system 110. In such an instance, the memory device 720 and/or the storage device 716 may store instructions which, when executed by the processor 718, cause the processor 718 to perform any feature or any combination of features described above as performed by the interface module 112 and/or the business rules module 114. In such an instance, the processor 718 may perform the feature or combination of features in conjunction with the memory device 720, communication interface 722, peripheral device interface 712, display device interface 714, and/or storage device 716.

Alternatively or additionally, an instance of the computing device 710 may be configured to perform any feature or any combination of features described above as performed by the web site system 120. In such an instance, the memory device 720 and/or the storage device 716 may store instructions which, when executed by the processor 718, cause the processor 718 to perform any feature or any combination of features described above as performed by the web application module 122 and/or the HTTP server module 124. In such an instance, the processor 718 may perform the feature or combination of features in conjunction with the memory device 720, communication interface 722, peripheral device interface 712, display device interface 714, and/or storage device 716.

Although FIG. 7 shows that the computing device 710 includes a single processor 718, single memory device 720, single communication interface 722, single peripheral device interface 712, single display device interface 714, and single storage device 716, the computing device may include multiples of each or any combination of these components 712, 714, 716, 718, 720, and 722 and may be configured to perform analogous functionality to that described above.

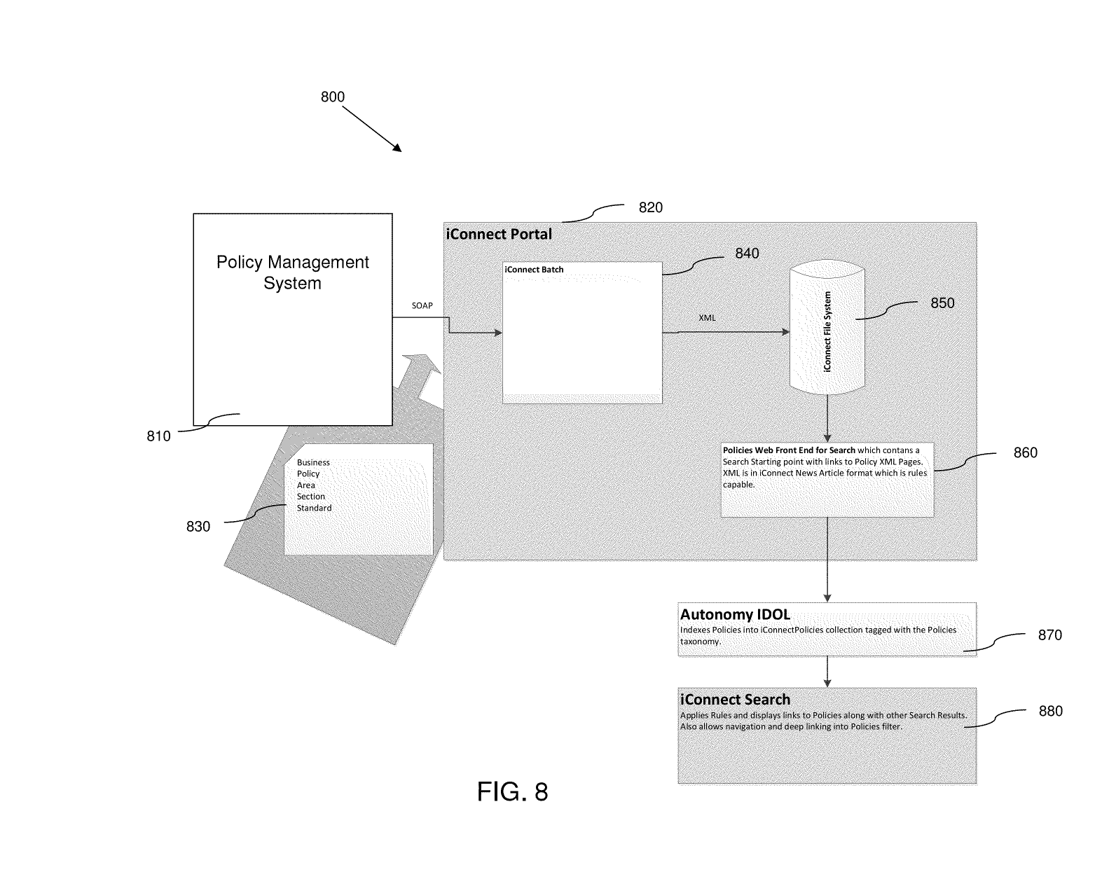

Referring now to FIG. 8, another exemplary embodiment of a system framework 800 of the present invention for managing and displaying policy data is shown. System framework 800 includes a policy management system 810 that is in communication with a company intranet portal 820, which serves as a corporate intranet communications network platform. Policy data 830 is transmitted to the portal 820 from the policy management system 810. Policy data 830 may be provide to a batch job or process 840 to fetch all the policies from the policy management system 810 and store them locally in intranet based file system 850. Policy data 830 is then segmented into separate files for each domain, policy, area, section and standard to align with the eventual display of pages on portal 820. In some embodiments, JAVA, XML and XSLT based processes may be used to accomplish these tasks. File system 850 is coupled to a web based front end 860 for the searching, viewing and accessing of policy data by one or more company employees or vendors. Web front end 860 may be further coupled to a search engine or search facility 870 to index the policies which may be implemented as a separate web site located on the portal 820 with access to portal cached pages containing searchable “documents” in XML format which align with the intranet portal pages. These pages may be configured in XML so metadata such as rules and taxonomy information (used for filtering) could be passed along to the search indexer along with the text of the policy. Search module 880 fetches search results from the search engine 870 and presents those results to users. Search filters may be implemented within search module 880 to allow users to filter on policies alongside any applicable search filters.

In embodiments where the company is in the financial services field, compliance policies may include, by way of non-limiting example, policies for compliance with FINRA. For investment companies, such as companies in the mutual fund segment of the financial services field, including advisers, policies may include policies required under SEC Rule 38a-1. These policies may include: policies and procedures that require the fund and its advisers to monitor for circumstances that may necessitate the use of fair value prices; establish criteria for determining when market quotations are no longer reliable for a particular portfolio security; provide a methodology or methodologies by which the fund determines the current fair value of the portfolio security; and regularly review the appropriateness and accuracy of the method used in valuing securities, and make any necessary adjustments; policies and procedures to verify that transfer agents and other intermediaries to segregate orders received by time of receipt in order to prevent “late trading” based on a previously determined price; policies and procedures to identify affiliated persons and prevent unlawful dealings with them; policies and procedures reasonably designed to prevent the adviser or any of its associated persons from misusing material, nonpublic information, such as including prohibitions against trading portfolio securities on the basis of information acquired by analysts or portfolio managers employed by the investment adviser, prohibiting the disclosure to third parties of material information about the fund's portfolio, its trading strategies, or pending transactions, and the purchase or sale of fund shares by advisory personnel based on material, nonpublic information about the fund's portfolio. For investment advisers, policies may include policies required under SEC Rule 206(4)-7. Examples of such policies include: Portfolio management processes, including allocation of investment opportunities among clients and consistency of portfolios with clients' investment objectives, disclosures by the adviser, and applicable regulatory restrictions; trading practices, including procedures by which the adviser satisfies its best execution obligation, uses client brokerage to obtain research and other services (“soft dollar arrangements”), and allocates aggregated trades among clients; proprietary trading of the adviser and personal trading activities of supervised persons; the accuracy of disclosures made to investors, clients, and regulators, including account statements and advertisements; safeguarding of client assets from conversion or inappropriate use by advisory personnel; the accurate creation of required records and their maintenance in a manner that secures them from unauthorized alteration or use and protects them from untimely destruction; marketing advisory services, including the use of solicitors; processes to value client holdings and assess fees based on those valuations; safeguards for the privacy protection of client records and information; and business continuity plans

Anti-Money Laundering (AML) and suspicious activity reporting (SAR) compliance policies may be applicable to insurance companies that issue certain life insurance products, such as cash value life insurance policies and annuities. Banks that act as insurance agents or brokers may need to institute compliance programs to report to an insurance company data relating to AML and SAR requirements. In the property and casualty insurance field, compliance policies may be employed in relation to state requirements for licensing of casualty claim adjusters, fire and extended peril/first party property insurance adjusters and subrogation recovery services personnel, state rules relating to timing of settlement of bodily injury claims, state regulations relating to disclosure of use of automobile replacement parts not from the manufacturer, state regulations relating to timing of notices, such as cancellation and other notices, to policy holders, and state regulations relating to information security requirements for maintaining confidentiality of certain customer information. The foregoing requirements and policies are merely exemplary.

Accordingly, the present invention promotes ready access and understanding of the obligations and requirements of corporate policies and standards that is critical to modern operational risk management. Having policies that are easily electronically accessible and easily searchable for employees and vendors is beneficial for corporate policy governance and risk posture and resolves many current issues with policy management, dissemination and education.

Although the methods and features described above with reference to FIGS. 1-8 are described above as performed using the example architecture 100 of FIG. 1 and the exemplary system 200 of FIG. 2, the methods and features described above may be performed using any appropriate architecture and/or computing environment. Although features and elements are described above in particular combinations, each feature or element can be used alone or in any combination with or without the other features and elements. For example, each feature or element as described with reference to FIGS. 1-8 may be used alone without the other features and elements or in various combinations with or without other features and elements. Sub-elements of the methods and features described above with reference to FIGS. 1-8 may be performed in any arbitrary order (including concurrently), in any combination or sub-combination.

What is claimed is:

1. A system for administering and displaying corporate policy data including interfacing a company intranet portal platform with a policy management platform, the system comprising:
at least one processor;
a memory coupled to the at least one processor;
and one or more programs, wherein the one or more programs are stored in the memory and configured to be executed by the at least one processor, the one or more programs including instructions for:
caching policy data in the intranet portal platform, the policy data associated with a plurality of corporate policy documents;
updating the corporate policy documents from one or more third party data sources;
determining a policy option selection of at least one employee based at least in part on the employee's role and historical viewing data;
configuring the determined policy option selection for display on a graphical user interface screen associated with the at least one employee; and
displaying the determined policy option selection on the graphical user interface screen associated with the at least one employee.

2. The system of claim 1, wherein determining a policy option selection of an employee based at least in part on employee role and historical data includes accessing an employee title associated with the employee.

3. The system of claim 1, wherein determining a policy option selection of at least one employee based at least in part on the employee's role and historical viewing data includes accessing stored historical data from the data storage device.

4. The system of claim 1, wherein updating the corporate policy documents from one or more third party data sources includes accessing a federal or state regulatory database.

5. The system of claim 1, wherein determining a policy option selection of an employee is based at least in part on a social media discussion or a current event.

6. The system of claim 1, wherein configuring the determined policy option selection for optimized display on a graphical user interface screen is based on the employee role.

7. The system of claim 1, wherein the one or more programs further include instructions for implementing business rules associated with policy display preferences based at least in part on employee role and employee historical preferences.

8. The system of claim 1, wherein the corporate policy documents comprise policies for one or more of portfolio management processes and trading practices.

9. The system of claim 1, wherein the company intranet portal includes a search facility for searching the corporate policy data stored on the policy management platform.

10. The system of claim 1, wherein the graphical user interface is configured for limited third party vendor access.

11. The system of claim 10, wherein the graphical user interface displays, upon third party vendor access, data indicative of vendor compliance with one or more standards of one or more corporate policies.

12. The system of claim 1, wherein the policy data includes policy data related to privacy, business resiliency, procurement and operational risk management.

13. A computer system for managing corporate policy documents stored in a policy management platform and cached to a corporate intranet communications network platform comprising:
a processor coupled to the corporate intranet communications network; and
at least one storage device in communication with the processor;
the processor configured to:
update a plurality of corporate policies for storage on the at least one storage device;
receive corporate policy requests via the corporate intranet communications network from one or more users, each user having an associated user profile;
selectively format for display the requested corporate policy based on the requesting user profile; and
display the corporate policy in accordance with the user profile.

14. The system of claim 13, wherein the programs further include instructions for caching policy data on one or more company intranet portal servers.

15. The system of claim 13, wherein selectively formatting for display the requested corporate policy based on the requesting user profile comprises providing collapsible and expandable display section of the corporate policy.

16. The system of claim 13, wherein displaying the corporate policy in accordance with the user profile comprises selectively displaying certain pre-determined sections of the corporate policy.

17. A computer-implemented method for administering insurance industry related policy data stored in a policy management system for use in an intranet environment comprising:
receiving, via the intranet environment, a policy option selection of at least one of a company employee and a company vendor;
configuring the requested policy option selection for display on a graphical user interface screen associated with the at least one of a company employee and a company vendor; and
displaying the determined policy option selection on the graphical user interface screen, wherein the policy data is cached in the intranet environment.

18. The computer-implemented method of claim 17, wherein configuring the determined policy option selection for display on a graphical user interface screen is based on an employee or vendor role.

19. The computer-implemented method of claim 17, wherein receiving, via the intranet environment, a policy option selection of at least one of a company employee and a company vendor comprises predictively providing a determined policy option selection to the employee or vendor based on social network or current event data.

20. The computer-implemented method of claim 17, further comprising monitoring vendor compliance with one or more policies.
